(19) United States
(12) Patent Application Publication
(10) Pub. No.: US 2008/0129198 A1
(43) Pub. Date: Jun. 5, 2008

(54) Light-emitting diode device

(75) Inventors: Jian Feng, Hong Kong (CN); Hung-Shen Chu, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Co. Ltd., Hong Kong (CN)

(21) Appl. No.: 11/607,066

(22) Filed: Dec. 1, 2006

(51) Int. Cl. H01J 1/62

(52) U.S. Cl. 313/506

(57) ABSTRACT

An LED device includes a multi-layer stack of materials having a p-layer, an n-layer, and a p-n junction for emission of light. The LED device further includes a p-electrode and an n-electrode for electrical connection between the respective p-layer and n-layer with an AC power source, and a capacitor located between one of the p-layer and n-layer and its respective electrode.

### FIELD OF THE INVENTION

The present invention relates generally to light emitting diode (LED) devices and more particularly to alternating current (AC) driven LED devices.

### BACKGROUND OF THE INVENTION

LEDs are semiconductor devices that emit light when an electrical current is supplied thereto, and traditionally have been driven by DC power sources. In recent developments, various circuitry designs have been proposed to drive the LEDs by using an AC power source.

For example, PCT publication no. WO2005/084080A2, entitled “AC Light Emitting Diode and AC LED Drive Methods and Apparatus” and published on Sep. 9, 2005, discloses an AC driven LED package having a pair of LEDs connected in an opposed parallel relationship, and a capacitor connected in series between the junction of the opposed parallel LEDs and an AC power source. However, as the capacitor does not emit light, the light emission efficiency of such an LED package may not be optimized. Further, such a LED package unavoidably requires various electrical connections to assemble a plurality of electrical components and may unnecessarily increase the cost, which also may not be desirable.

It is an object of the present invention to provide an AC driven LED device, which overcomes at least some of the deficiencies exhibited by those of the prior art.

### SUMMARY OF THE INVENTION

According to a first aspect of the present invention, there is provided an alternating current (AC) driven light emitting diode (LED) device. The LED device includes a multi-layer stack of materials having a p-layer, an n-layer, and a p-n junction for emission of light, a p-electrode and an n-electrode for electrical connection between the respective p-layer and n-layer with an AC power source, and a capacitor located between one of the p-layer and n-layer and its respective electrode.

Preferably the capacitor includes a pair of conductive plates and at least one dielectric layer located therebetween.

Preferably the pair of plates of the capacitor are substantially parallel to each other. More preferably the pair of plates of the capacitor are substantially parallel to said one of the p-layer and n-layer.

The conductive plates of the capacitor and the dielectric layer allow at least partial transmission of light therethrough.

Each of the conductive plates may be formed from an Indium-Tin Oxide (ITO) film. Accordingly, the conductive plates may be formed from a Zn Oxide film.

Preferably one of the pair of conductive plates of the capacitor is formed by said corresponding electrode.

Preferably the capacitor extends substantially across a width of said one of the p- and n-layers.

Preferably the capacitor includes a pair of conductive plates and at least one dielectric layer therebetween, wherein one of the conductive plates that is proximal to said one of the p-layer and n-layer extends substantially across a width of said one of the p-layer and n-layer.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

The invention now will be described, by way of example only, and with reference to the accompanying drawings in which:

FIG. 1a shows a cross-section view of a first embodiment of the AC driven LED device of the present invention;

FIG. 1b shows a simplified electrical circuitry diagram of the LED device of FIG. 1a;

FIG. 2a shows a cross-section view of a second embodiment of the AC driven LED device of the present invention;

FIG. 2b shows a simplified electrical circuitry diagram of the LED device of FIG. 2a;

FIG. 3. shows a cross-section view of a third embodiment of the AC driven LED device of the present invention;

FIG. 4a shows a cross-section view illustrating current spreading in a conventional LED device; and

FIG. 4b shows a cross-section view illustrating current spreading in the LED device of FIG. 1.

### DETAILED DESCRIPTION

The following description refers to exemplary embodiments of an AC-driven LED device according to the present invention. Reference is made in the description to the accompanying drawings whereby the light emitting diode is illustrated in the exemplary embodiments. Similar components between the drawings are identified by the same reference numerals.

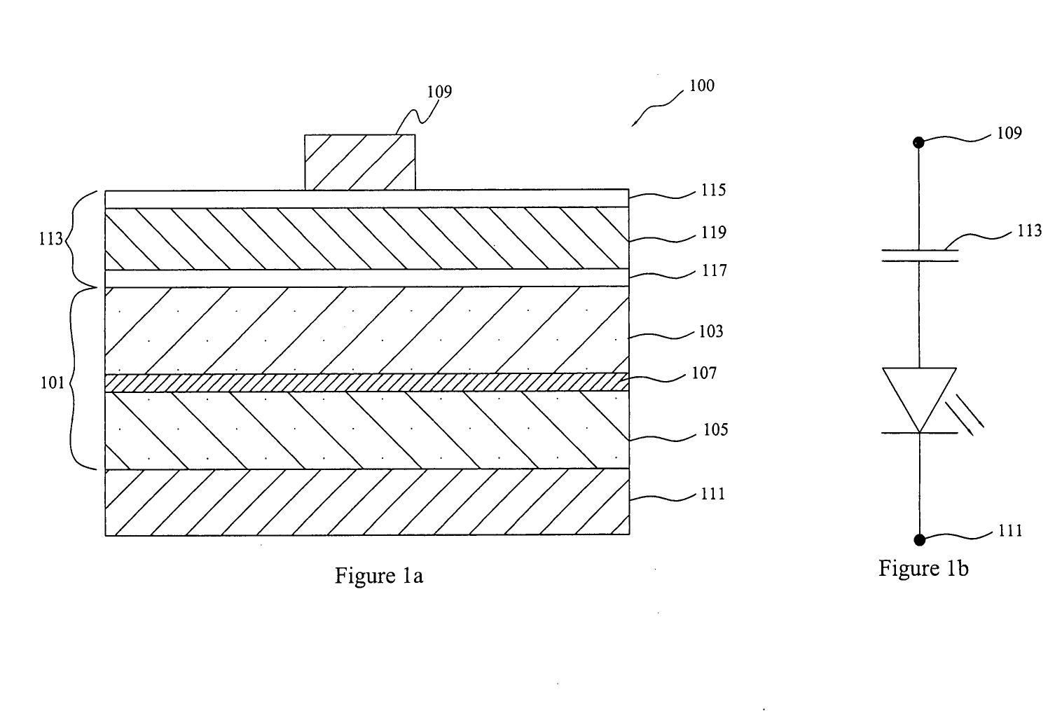

Referring to FIGS. 1a and 1b, an exemplary embodiment of a vertical AC driven LED device 100 according to the present invention is shown, the device 100 including a multi-stack 101 having a layer of p-doped material or p-layer 103, a layer of n-doped material or an n-layer 105, and a light generating region or p-n junction 107 as generally understood in the art. The vertical LED device 100 further includes a p-electrode 109 and an n-electrode 111 for supplying electrical power to the p- and n-layers 103, 105 respectively.

Furthermore, the vertical LED device 100 includes an embedded capacitor 113 formed by sequentially depositing a pair of substantially parallel conductive plates 115, 117 and at least one dielectric layer 119 therebetween on or adjacent the p-layer, with the conductive plates 115, 117 electrically connected to the p-electrode 109 and p-layer 103 respectively. With such an embedded capacitor, the exemplary embodiment of the AC driven LED device does not require extra external capacitor components when connected to an AC power source such that the external driving circuitry in the LED package can be simplified. Due to the reduction in the number of the external components, a LED package with such LEDs located therein can have a relatively higher light emission efficiency than those of the prior art Further, as the conductive plate and dielectric layer of the capacitor can be easily deposited onto the p-layer by using for example coating technology, the addition of an embedded capacitor to the LED device does not necessarily make the fabrication of such an LED device more complicated.

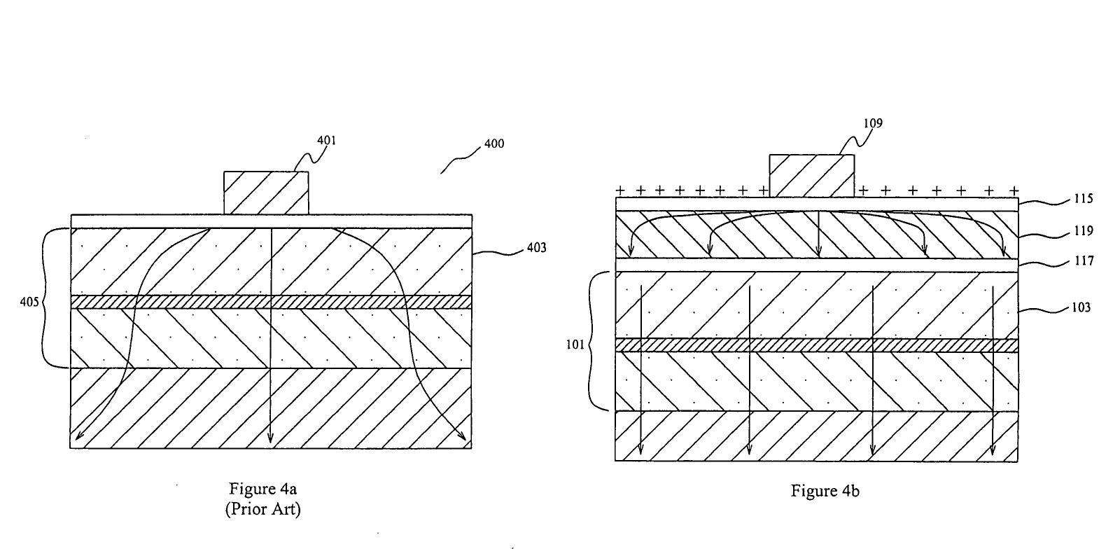

Due to the AC current driven coupling effect, an ordinarily skilled person in the art will appreciate that a better or more even current spreading across the multi-stack layer 101 can be achieved by the exemplary embodiment as shown in FIG. 4b, as compared to that of a conventional LED device 400 as shown in FIG. 4a. Furthermore, in the first exemplary embodiment, the capacitor 113 extends substantially parallel to and across the width of the p-layer 103 for improving the current spreading across the multi-stack layer 101.

In addition, in the exemplary embodiment illustrated in FIGS. 1a and 1b, the capacitor 113 is substantially transparent, with the conductive plates 115, 117 formed from transparent conductive material such as Indium-Tin Oxide (ITO) film or a Zn Oxide film and the dielectric layer 119 formed from transparent dielectric material such as SiO₂. An ordinarily skilled person in the art will appreciate that other or alternate materials may also be used. For example a 1-dimensional photonic crystal structure can be used to form the dielectric layer.

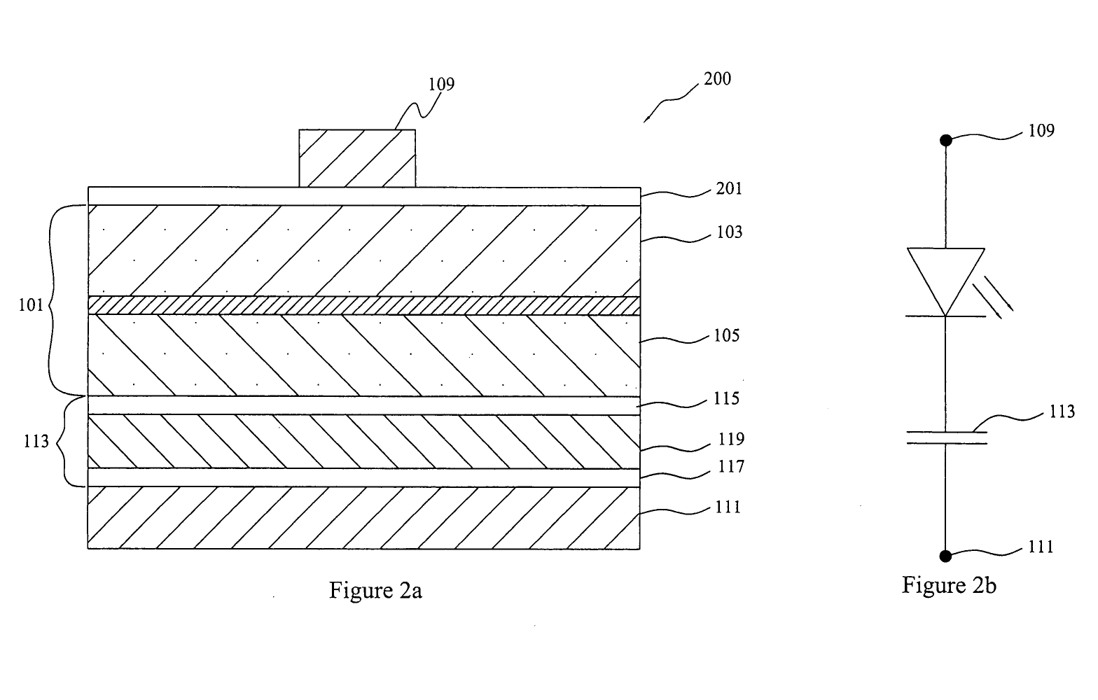

FIG. 2 illustrates a second exemplary embodiment of a vertical AC-driven LED device 200 according to the present invention, which has a similar structure to the first embodiment 100 however with the capacitor 113 formed between the n-layer 105 and n-electrode 111. The vertical LED device 200 may also include an ITO layer between the p-electrode 109 and p-layer 103 for improvement of electrical contact therebetween. Furthermore, as the capacitor 113 is located below the n-layer 105, non-transparent materials may be used to form the conductive plates 115, 117 and dielectric layer 119.

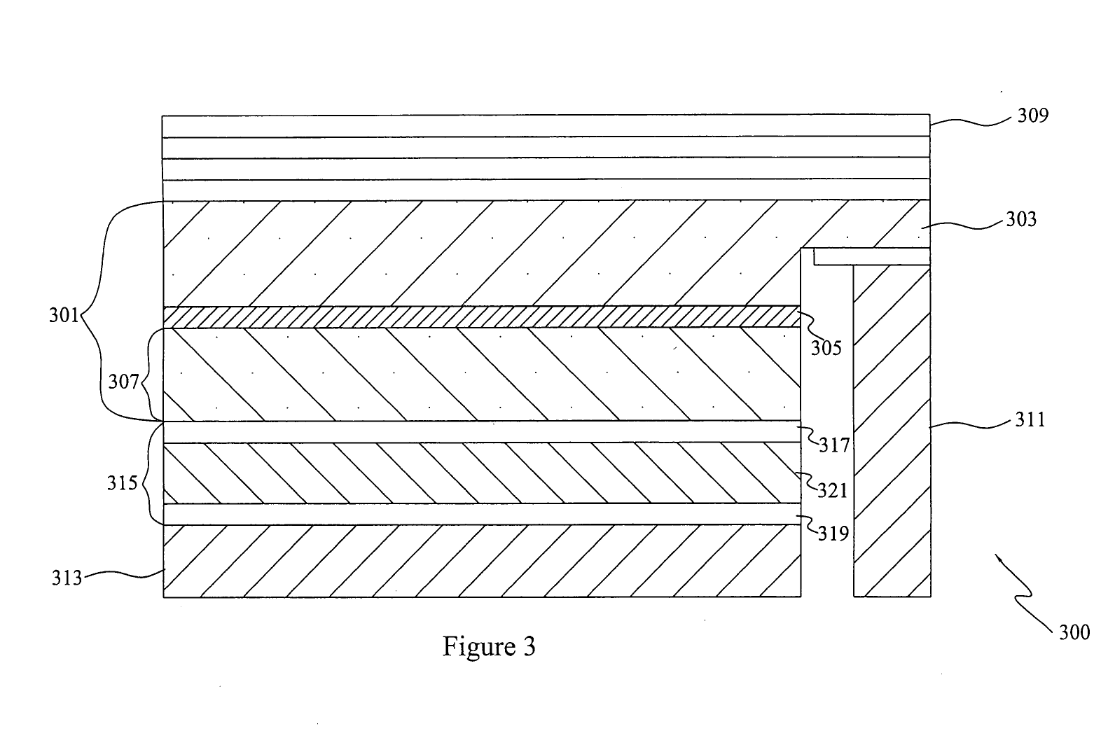

In FIG. 3, a third exemplary embodiment of a flip-chip LED device 400 according to the present invention is shown. The flip-chip light emitting device 300 has a multi-stack 301 including a layer of p-doped material or p-layer 303, a layer of n-doped material or an n-layer 707, and a light generating region or p-n junction 305 sequentially formed on a substantially transparent substrate 309 as generally understood in the art. The flip-chip LED device 300 further includes a p-electrode 311 and an n-electrode 313 for supplying electrical power to the p- and n-layers 303, 307 respectively.

Similarly to the exemplary vertical LED device 200 illustrated in FIG. 2a, the flip-chip LED device 300 includes an embedded capacitor 315 having a pair of conductive plates 317, 319 and a dielectric layer 321 located therebetween, with the conductive plates 317, 319 electrically connected to the n-electrode 313 and n-layer 307 respectively and the capacitor 315 extending substantially parallel to and across the width of the n-layer 307. Furthermore, the conductive plates 317, 319 and a dielectric layer 321 are not required to be transparent materials as they will not block light emission through the substrate 309.

In an alternative embodiment, the embedded capacitor may be formed between the p-electrode 311 and the p-layer 303 although an ordinarily skilled person in the art will appreciate that such an alternative design may have relatively limited effect on the current spreading across the multi-stack layers.

Exemplary embodiments of AC driven LED device of the present invention have been described with reference to both vertical and flip-chip LED devices. An ordinarily skilled person will appreciate that a similar embedded capacitor design is also applicable to a top-emitting LED device, that is, an AC-driven LED device can also be formed with an embedded capacitor between one of its p- and n-layer and its respective electrode.

Alternatives can be made to the above-described embodiments. For example, in the embodiment of FIGS. 1a and 1b, the p-electrode 109 may also act as conductive plate of the capacitor such that conductive plate 115 is integrated with or formed by p-electrode 109. Similar alternatives can be made to other embodiments of the invention.

It will be understood that the invention disclosed and defined herein extends to all alternative combinations of two or more of the individual features mentioned or evident from the text or drawings. All of these different combinations constitute various alternative aspects of the invention. The foregoing describes an embodiment of the present invention and modifications, apparent to those skilled in the art can be made thereto, without departing from the scope of the present invention.

Although the invention is illustrated and described herein as embodied, it is nevertheless not intended to be limited to the details described, as various modifications and structural changes may be made therein without departing from the spirit of the invention, and within the scope and range of equivalents of the claims.

Furthermore, it will be appreciated and understood that the words used in this specification to describe the present invention and its various embodiments are to be understood not only in the sense of their commonly defined meanings, but also to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result, without departing from the scope of the invention.

What is claimed is:

1. An alternating current (AC) driven light emitting diode (LED) device comprising
a multi-layer stack of materials including a p-layer, an n-layer, and a p-n junction for emission of light;
a p-electrode and an n-electrode for electrical connection between the respective p-layer and n-layer with an AC power source; and
a capacitor located between one of the p-layer and n-layer and its respective electrode.

2. The LED device of claim 1, wherein the capacitor includes a pair of conductive plates and at least one dielectric layer located therebetween.

3. The LED device of claim 2, wherein the pair of plates of the capacitor are substantially parallel to each other.

4. The LED device of claim 3, wherein the pair of plates of the capacitor are substantially parallel to said one of the p-layer and n-layer.

5. The LED device of claim 2, wherein the conductive plates of the capacitor and the dielectric layer allow at least partial transmission of light therethrough.

6. The LED device of claim 5, wherein each of the conductive plates is formed from an Indium-Tin Oxide (ITO) film.

7. The LED device of claim 5, wherein each of the conductive plates is formed from a Zn Oxide film.

8. The LED device of claim 2, wherein one of the pair of conductive plates of the capacitor is formed by said corresponding electrode.

9. The LED device of claim 1, wherein the capacitor extends substantially across a width of said one of the p-layer and n-layer.

10. The LED device of claim 9, wherein the capacitor includes a pair of conductive plates and at least one dielectric layer therebetween, wherein one of the conductive plates that is proximal to said one of the p-layer and n-layer extends substantially across a width of said one of the p-layer and n-layer.
